(19) United States
(12) Patent Application Publication
(10) Pub. No.: US 2015/0370439 A1
(43) Pub. Date: Dec. 24, 2015

(54) GPU-OPTIMIZED SCROLLING SYSTEMS AND METHODS

(71) Applicant: salesforce.com, inc., San Francisco, CA (US)

(72) Inventor: Diego Ferreiro Val, San Francisco, CA (US)

(73) Assignee: SALESFORCE.COM, INC., San Francisco, CA (US)

(21) Appl. No.: 14/744,111

(22) Filed: Jun. 19, 2015

Related U.S. Application Data
(60) Provisional application No. 62/016,441, filed on Jun. 24, 2014.

(51) Int. Cl. G06F 3/0485; G06F 3/0482

(52) U.S. Cl. CPC G06F 3/0485; G06F 3/0482

(57) ABSTRACT

A scrolling method includes producing a render tree associated with a plurality of web resources and a plurality of displayable components then providing a subset of the plurality of displayable components to a graphics processing unit such that each of the displayable components has its own corresponding layer. The method further includes receiving a scroll gesture indicative of a request to scroll the plurality of displayable components, determining a scroll behavior based on the scroll gesture, and sequentially modifying and rendering the subset of the plurality of displayable components based on the scroll behavior.

### CROSS-REFERENCE TO RELATED APPLICATIONS

This application claims priority to U.S. Provisional Patent Application No. 62/016,441, filed Jun. 24, 2014, the contents of which are hereby incorporated by reference.

### TECHNICAL FIELD

Embodiments of the subject matter described herein relate generally to computer systems, and more particularly relate to systems and methods for managing the scrolling of web pages and other such content in such computer systems.

### BACKGROUND

Recent years have seen significant advances in user interface design in the context of computing devices, particularly those devices—such as tablets and smart phones—that are often used for browsing web content available over the Internet. There are still many opportunities for improvement, however.

For example, one of the core requirements of any web browser is the ability to scroll through web pages that are too large to be displayed in their entirety on the device screen. Ideally, scrolling should proceed smoothly and at an appropriate speed such that the user does not experience any hesitation or other unusual animation artifacts. This can be a problem, particularly in resource limited devices, because the relatively small memory of such devices prevents a sufficient number of the displayable components to be stored and manipulated in real-time.

Furthermore, the manner in which displayable content is rendered and scrolled in a browser typically requires many redraw events, which can be taxing for even powerful processors and graphics processing units (GPUs). In addition, the browser will often not know, until the scroll animation has completed, which component is to be displayed at the end of the scroll event. As a result, such a browser will often display one or more dummy “placeholder” graphics during scrolling.

While techniques exist for providing limited scrolling using a scrolling region programmatically provided within the web page, e.g., via cascading style sheet (CSS) transitions, such methods can be slow, and are not extensible—i.e., they do not allow for rich customization of animation behavior.

Accordingly, systems and methods are desired for improving the scrolling of content in the context of web pages and the like.

### BRIEF SUMMARY

A scrolling method in accordance with one embodiment includes producing a render tree associated with a plurality of web resources and a plurality of displayable components; providing a subset of the plurality of displayable components to a graphics processing unit such that each of the displayable components has its own corresponding layer; receiving a scroll gesture indicative of a request to scroll the plurality of displayable components; determining a scroll behavior based on the scroll gesture; and sequentially modifying and rendering the subset of the plurality of displayable components based on the scroll behavior.

A computing system in accordance with one embodiment includes a processing system and a memory, wherein the memory comprises computer-executable instructions that, when executed by the processing system, cause the computing system to: produce a render tree associated with a plurality of web resources and a plurality of displayable components; provide a subset of the plurality of displayable components to a graphic processing unit such that each of the displayable components has its own corresponding layer; receive a scroll gesture indicative of a request to scroll the plurality of displayable components; determine a scroll behavior based on the scroll gesture; and sequentially modify and render the subset of the plurality of displayable components based on the scroll behavior.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a conceptual overview of scrollable content and associated displayable components in accordance with an exemplary embodiment;

FIG. 2 illustrates operation of a computing device displaying scrollable content in accordance with an exemplary embodiment;

FIG. 3 is a conceptual block diagram of a computing device in accordance with an exemplary embodiment;

FIG. 4 is a conceptual block diagram of a scroller module in accordance with an exemplary embodiment;

FIG. 5 is a conceptual illustration of display items distributed over multiple layers;

FIG. 6 is a flow diagram of an exemplary process in accordance with one or more embodiments; and

FIG. 7 is a conceptual view of a render tree in accordance with one embodiment.

### DETAILED DESCRIPTION

Embodiments of the subject matter described herein generally relate to an extensible platform that provides GPU-optimized scrolling in the context of a web browser or the like. By combining mathematically specified scrolling behavior with the “recycling” of the render tree at the GPU, a smooth scrolling experience can be provided, even when a very large number of items are displayed.

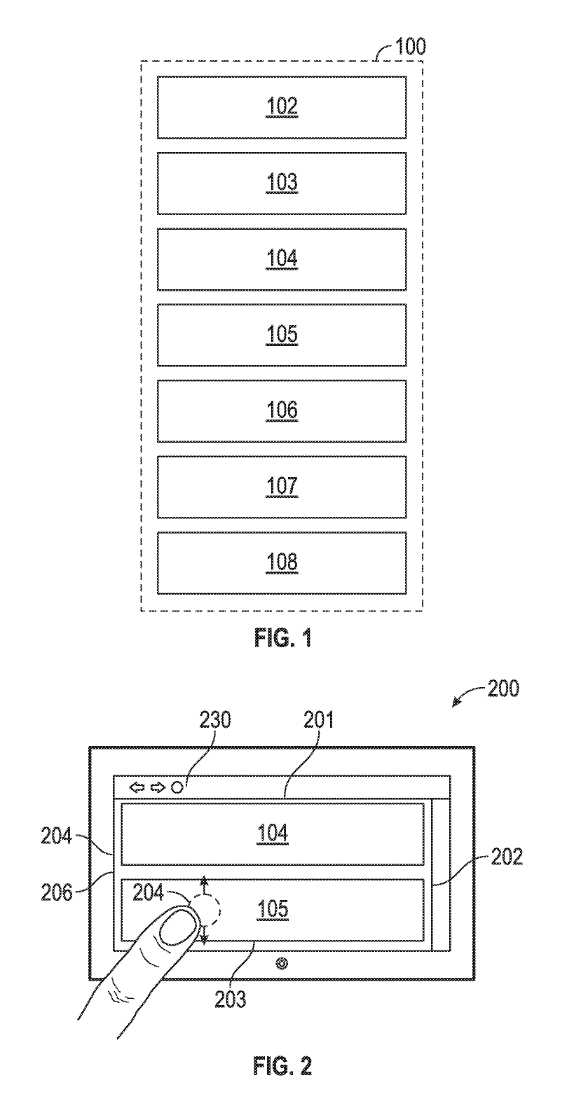

FIG. 1 illustrates, in a conceptual manner, an example of scrollable content (or simply “content”) 100 comprising a number of displayable components (or simply “components”) 102-108. Displayable components 102-108 may include a wide range of items of the type conventionally rendered and displayed by web browsers and other such graphically intensive software applications. For example, displayable components 102-108 might include, without limitation, various text components, image components (e.g., JPG, PNG, etc.), video components (e.g., AVI, animated-GIFs, etc.), interactive user interface components (e.g., buttons, text entry regions), widgets, and the like. Content 100, and thus components 102-108, will often be produced by a software application (e.g., a web browser) configured to parse and render one or more web resources, such as hypertext transfer markup language (HTML) files, cascading style sheet (CSS) files, Javascript code, and other such files used in connection with the world wide web.

Referring now to the conceptual block diagram of FIG. 2 in conjunction with FIG. 1, an example computing device 200 suitable for providing the functionality described herein generally includes any combination of software and hardware configured to display (in a scrollable manner) content 100, e.g., via web browser 230 running on computing device 200. Computing device 200 might be implemented as a tablet (e.g., with a touch-screen display region 206), a smartphone, a desktop computer, a mobile device, a laptop computer, or any other such computing device in which scrolling of content 100 may be desired.

Browser 230 may correspond to any of the variety of web browsers known in the art, such as Microsoft Internet Explorer, Mozilla Firefox, Google Chrome, Apple Safari, Opera, or the like. Similarly, browser 230 may implement a variety of application programming interfaces (APIs) and include any suitable layout engine. In that regard, while the various examples presented herein are often described in the context of the Webkit layout engine and its commands, the invention is not so limited. Other layout engines, such as Trident and Gecko, may be employed. Browser 230 will generally include a user interface, a browser engine, a rendering engine, a Javascript interpreter, and a variety of other functional components known in the art.

As illustrated, content is displayed by browser 230 within a rectangular region defined by edges 201, 202, 203, and 204. Because the area defined by edges 201-204 is significantly smaller than the total area of content 100, only a portion of content 100 can be displayed by computing device 200 at any particular time. In FIG. 2, for example, only components 104 and 105 are all or partially displayed. To make the entirety of content 100 available to the user, computing device 200 is configured such that a user, via a finger, mouse (and corresponding cursor arrow), or other such input object 202 may generate a “scroll” gesture—e.g., make contact with display 206 in a contact region 204 and then translate the input object 202 in a vertical (and/or horizontal) fashion to effectively “scroll” and display other portions of content 100.

Thus, for example, movement of input object 202 upward (relative to FIG. 2), will generally result in a corresponding upward movement of content 100, thereby revealing addition components (such as components 107, 108, an 109) while removing from view other components (such as components 101 and 103). The apparent movement of content 100 is the result of displaying multiple frames at a particular frame-rate, as described in detail below. The greater the frame-rate, the “smoother” and more responsive the scrolling appears to the user.

After input object 202 is removed from contact region 204 (in many cases with a “flicking” action), the displayed content 100 will generally translate in accordance with a particular scrolling behavior and then eventually “settle” to a stationary position. Certain “bounces” or other animations (e.g., “pull to refresh”) may also be implemented. As will be understood, computing device 200 will generally be capable of interpreting a wide range of gestures, including pinch movements and the rotation and translation of multiple input objects 202 (e.g., “multi-touch”). In general, then, computing device 200 is capable of determining (1) whether input object 202 is “in contact” with display 206, and (2) the effective position (or positions) of any contact regions 204.

As will be described in further detail below, scrolling of content 100 within browser 230 is accomplished not through the browser's built-in browser functionality, but by a “scroller” object (or objects) incorporated (via HTML/CSS/Javascript) into the displayed region of browser 230. The scroller manages the movement of the content 100 via efficient use of a graphics processing unit (GPU) provided within computing device 200.

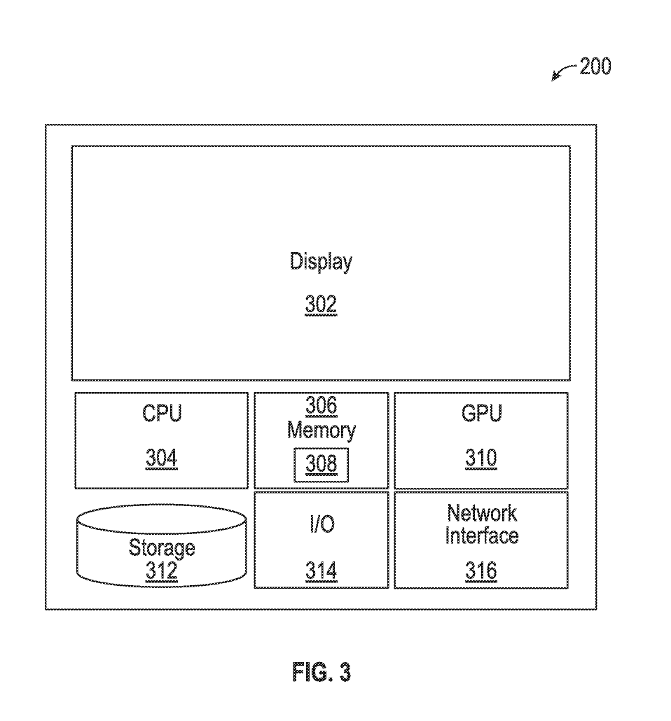

More particularly, referring to FIG. 3, computing device 200 will generally include a display (e.g., a touch-screen display) 302, a central processing unit (CPU) 304, one or more memory components 306, a GPU 310, a network interface 316 (e.g., WiFi, Ethernet, or the like), and one or more input/output interfaces. CPU 304 is configured execute machine readable software code 308 (which might correspond to any and all of the various software components described herein) and, via GPU 310, render content 100 on display 302. GPU 310 may include any of the various GPU components known in the art that are capable of interfacing with CPU 304 (via an appropriate GPU API) to render display 302. The nature of such GPUs are known in the art, and need not be described in detail herein.

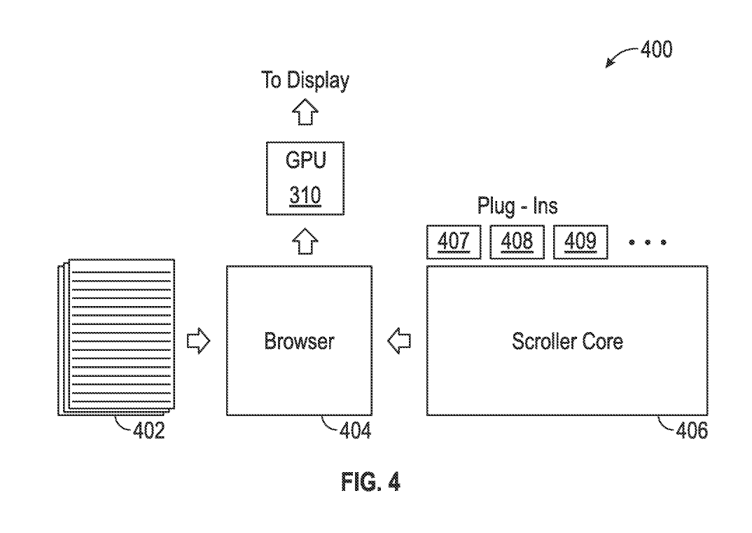

FIG. 4 illustrates a scroller system 400 in accordance with one embodiment that includes a browser 404, scroller core (or simply “scroller”) 406, and one or more optional plug-ins 407-409. Browser 404 is configured to receive any number of web resources 402 composing a typical web page with scrollable content. Web resources 402 will typically include one or more HTML files, CSS files, Javascript files, and digital assets (images, videos, etc.). One or more web resources 402 instructs browser 404 to access the scroller core 406 and any plug-ins 407-409. For example, an HTML web page might include a Javascript import statement (“<script>”) to import Javascript code corresponding to scroller 406 and plug-ins 407-409.

In general, browser 404, in conjunction with scroller 406, any plug-ins 407-409, and GPU 310, are configured to parse web resources 402 to first construct a document object model (DOM) tree. That is, HTML tags (“<body>”, “<table>”, etc.) within resources 402 are used to create a “content tree” corresponding to the displayable content. The corresponding CSS file is then parsed and combined with the content tree to produce a “render tree.” The render tree includes shape information for the various displayable content as well as visual attributes, such as colors and dimensions. Such a render tree 700 is illustrated, conceptually, in FIG. 7, which shows a hierarchically arranged set of nodes (701-706), each corresponding to a particular component along with its visual attributes. For example, node 701 might correspond to header text having particular font characteristics, while node 702 might correspond to a JPG image sized to fit within a specified rectangular area. FIG. 7 may be stored, for example, in memory 306 of FIG. 3.

After construction of the render tree, a “layout” process is performed to determine where each node of the render tree 700 should appear on the display. All or a portion of the render tree is provided to GPU 310, which then “rasterizes” (pixel by pixel) the render tree 700 to produce the final image for the display.

As noted above, one problem with known scrolling schemes is that, when the render tree 700 contains a large number of displayable components, the memory of the computing device (306 in FIG. 3) may not be capable of storing the content required to produce a smooth scrolling experience. Furthermore, during fast scrolling, the computing device will generally only know which displayable components to display after the scrolling has finished. To address these and other such problems, scroller 406 is configured such that the scroll behavior is mathematically determined based on a known frame rate (so that the future position of all displayable elements can be precisely determined ahead of time) and the render tree is “recycled” by the GPU during a scroll event—that is, displayable components are removed and added only as necessary. Furthermore, the scroller 406 is configured to accept plug-ins 407-409 to further extend its functionality in a simple manner, such as adding a variety of visual effects.

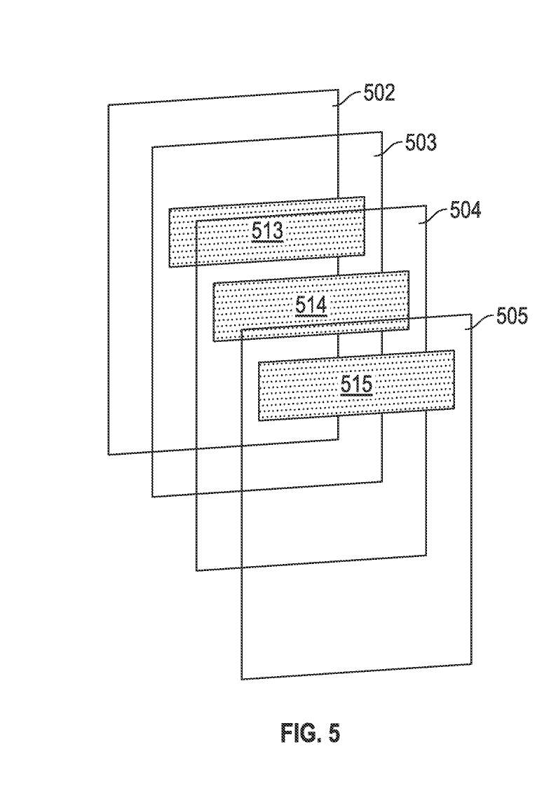

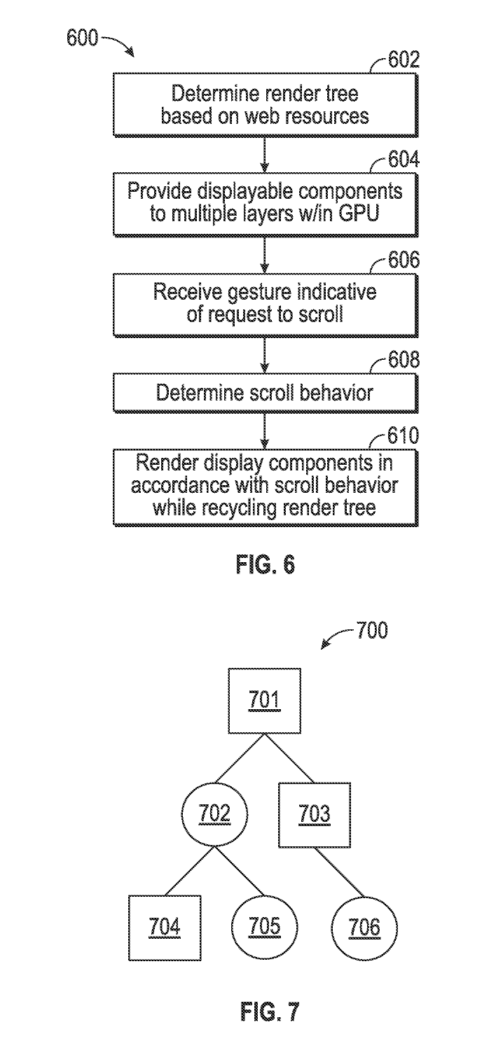

FIG. 6 is a flowchart depicting a scrolling procedure in accordance with one embodiment. Initially, as briefly described above, the system 400 determines the render tree (700 in FIG. 7) based on web resources 402. After which, in step 604, a portion of the displayable components are provided to GPU 310 in such a way that each of the displayable components has its own layer. That is, GPU 310 will generally be capable of storing an image or multiple images in one or more discrete layers. This is particularly advantageous, for example, where an image itself does not often change, but its position, orientation, and/or other attributes might change quickly (as is often the case with a scroll event). By using multiple layers, it is not necessary for an entire image to be withdrawn every time there is a change in one of the displayable components. This is shown in FIG. 5, which depicts, conceptually, a display area 502 and multiple layers 503-504 used to store corresponding displayable components 513-515.

Forcing the displayable components to reside on individual layers may be accomplished in a number of ways, depending upon the nature of GPU 310 and browser 404. In one embodiment, in which browser 404 utilizes the Webkit library, each displayable component is subjected to a webkit matrix3d transformation that specifies the relative position of each displayable component. That is, the 4×4 matrix passed to the matrix3d function (which controls translation, scaling, and rotation) is selected to effect a desired motion during the scroll event. In accordance with one embodiment, an HTML/Javascript “surface.dom.style” transform is used, wherein the 4×4 matrix includes “offsetX” and “offsetY” variables that specify the position of a displayable component during scrolling, as in the following command: surface.dom.style[STYLES.transform]=‘matrix3d(1,0,0,0,0,1,0,0,0,0,1,0,’+offsetX+‘,’+offsetY+‘, 0, 1)’. In this example, the system forces a layer to be promoted (at a GPU level) by using translate3d( )or matrix3d( ) command. In other embodiments, a more general command, such as the “will-change” CSS selector may be used (see, e.g., the W3C (standardization committee) document http://www.w3.org/TR/2014/WD-css-will-change-1-201404294/).

Referring again to FIG. 6, after the displayable components are provided to the GPU in separate layers, the system receives a gesture indicative of a request to scroll. This gesture might include, for example, dragging a finger or stylus across a touch screen, clicking and dragging a cursor, manipulating the computing device itself (utilizing any onboard accelerometers), or the like. In response, at step 608, the system mathematically determines the scrolling behavior that will take place. That is, given a known mathematical function and a specified frame rate, the system can determine the exact position of each displayable component during the entire scroll event (e.g., after the user has ended the scrolling with a “flicking” gesture). A variety of mathematical functions may be used for this purpose, but in one embodiment a cubic Bezier CSS timing function is employed at 60 frames-per-second. The cubic Bezier is an advantageous animation timing function in that it is easy to specify (requires only four real numbers as input) and can be easily computed in real time. For example, an easing variable may be used as follows: EASING_REGULAR=CubicBezier(0.33, 0.66, 0.66, 1). The Cubic-bezier is also advantageous in that it better approximates the real theoretical physics equation associated with scrolling, and it is easy to compute. As an implementer, one can choose to override this function with any other desired function.

Once the system knows the precise location of each of the displayable components during the scroll event, the system (via GPU 310) renders and composites the displayable components in accordance with the known scroll behavior while “recycling” the render tree. That is, referring again to FIGS. 1 and 2, instead of animating all of the components 102-108, only a subset (e.g., 103-106) of those components are animated, sequentially modifying and rendering the subset of displayable components based on the scroll behavior. This subset will generally include the components currently being displayed as well as some predetermined number of items one either side (in the scroll direction). Stated another way, when component 104 exits top edge 201 by a sufficient distance during a scroll event, that component is removed from the GPU (i.e., recycled). At the same time, item 106 is placed into the GPU for animation. In this way, a very large number of components 100 can be handled, even in computing devices with low memory and processing capabilities. The recycling of components may be accomplished in a variety of ways.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to touchscreen systems, HTML and related technologies (Javascript, CSS, the DOM, etc.), GPUs, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A scrolling method comprising:
producing a render tree associated with a plurality of web resources and a plurality of displayable components;
providing a subset of the plurality of displayable components to a graphics processing unit such that each of the displayable components has its own corresponding layer;
receiving a scroll gesture indicative of a request to scroll the plurality of displayable components;
determining a scroll behavior based on the scroll gesture; and
sequentially modifying and rendering the subset of the plurality of displayable components based on the scroll behavior.

2. The scrolling method of claim 1, wherein determining the scroll behavior includes determining a cubic-Bezier behavior.

3. The scrolling method of claim 1, wherein the subset of the plurality of displayable components are provided to the graphics processing unit via transformation commands.

4. The scrolling method of claim 3, wherein the transformation commands include a Javascript surface.dom.style transform or a CSS selector.

5. The scrolling method of claim 1, wherein the displayable components are selected from the group consisting of text components, image components, video components, and widgets.

6. The scrolling method of claim 1, wherein rendering the subset of the plurality of displayable components includes utilizing a web browser to render the subset of the plurality of displayable components.

7. The scrolling method of claim 1, further including recycling the render tree based on the scroll gesture.

8. A computing system comprising a processing system and a memory, wherein the memory comprises computer-executable instructions that, when executed by the processing system, cause the computing system to:
produce a render tree associated with a plurality of web resources, the render tree associated with a plurality of displayable components;
provide a subset of the plurality of displayable components to a graphic processing unit such that each of the displayable components has its own corresponding layer;
receive a scroll gesture indicative of a request to scroll the plurality of displayable components;
determine a scroll behavior based on the scroll gesture; and
sequentially modify and render the subset of the plurality of displayable components based on the scroll behavior.

9. The computing system of claim 8, wherein the memory further comprises at least one plug-in comprising computer-executable instructions that, when executed by the processing system, cause the computing system to modify the scrolling behavior based in part on the at least one plug-in.

10. The computing system of claim 8, wherein the scroll behavior is a cubic-Bezier behavior.

11. The computing system of claim 8, wherein the subset of the plurality of displayable components are provided to the graphics processing unit via transformation commands.

12. The computing system of claim 11, wherein the transformation commands include a Javascript surface.dom.style transform or a CSS selector.

13. The computing system of claim 8, wherein the displayable components are selected from the group consisting of text components, image components, video components, and widgets.

14. The computing system of claim 8, wherein the subset of the plurality of displayable components is rendered with a web browser.

15. The computing system of claim 8, wherein the processor-executable instructions further cause the processor to recycle the render tree based on the scroll gesture.

16. A computer-readable medium comprising processor-executable instructions that, when executed by one or more processor devices, are capable of performing the steps of:
producing a render tree associated with a plurality of web resources and a plurality of displayable components;
providing a subset of the plurality of displayable components to a graphics processing unit such that each of the displayable components has its own corresponding layer;
receiving a scroll gesture indicative of a request to scroll the plurality of displayable components;
determining a scroll behavior based on the scroll gesture; and
sequentially modifying and rendering the subset of the plurality of displayable components based on the scroll behavior.

17. The computer-readable medium of claim 16, wherein determining the scroll behavior includes determining a cubic-Bezier behavior.

18. The computer-readable medium of claim 16, wherein the subset of the plurality of displayable components are provided to the graphics processing unit via transformation commands.

19. The computer-readable medium of claim 16, wherein the transformation commands include a Javascript surface.dom.style transform or a CSS selector.

20. The computer-readable medium of claim 16, wherein the displayable components are selected from the group consisting of text components, image components, video components, and widgets.
